(19) United States
(12) Patent Application Publication
(10) Pub. No.: US 2004/0031190 A1
(43) Pub. Date: Feb. 19, 2004

(54) System and methods for monitoring arthropods

(76) Inventors: James Robert Collins, Glen Mills, PA (US); James Bruce Ballard, Medford, NJ (US); John Francis Wright, Cherry Hill, NJ (US); Neil Anthony Destefano, Southampton, NJ (US); Donald Frederick Claus, Glen Mills, PA (US)

Correspondence Address: John M Sheehan, FMC Corporation, 1735 Market Street, Philadelphia, PA, 19103, US

(21) Appl. No.: 10/398,838

(22) PCT Filed: Oct. 12, 2001
(86) PCT No.: PCT/US01/32038

(51) Int. Cl. A01M 1/20

(52) U.S. Cl. 43/132.1

(57) ABSTRACT

Arthropod monitoring stations are provided, as well as methods for using them. The stations comprise a housing having a first end, a second end, and lateral wall extending between the first end and the second end. The first end, second end, and lateral wall substantially define an interior portion of the housing, and at least one of the first end, the second end, and the lateral wall includes at least one aperture suitable for ingress or egress by an arthropod with rest to said interior of said housing. Preferably, at least two members are disposed within the housing, each of the members having a first end, a second end, and a lateral wall extending between the first end and the second end. At least one of the members comprises a material capable of being consumed by arthropods, a material capable of being penetrated by arthropods, a material capable of being transported by arthropods, or a material capable of killing arthropods.

### BACKGROUND OF THE INVENTION

The present invention relates to the monitoring and/or controlling of arthropods such as termites and, in particular, to devices that are placed in the ground and can be used to monitor and/or control populations of arthropods.

Termites are well known throughout most areas of the world as insects that attack and destroy wooden structures. Subterranean termites most often enter structures from the surrounding soil to feed on wood or other cellulosic material of the structure and its contents. Many methods for killing termites have been employed over the years. One such method involves applying a toxicant (i.e., a material that kills or repels termites) to the soil in the vicinity of a structure that is to be protected from termites. Not only is this type of treatment labor intensive and raises issues about soil contamination, but the application may not produce an adequate barrier to termite infestation.

Another approach to termite control involves the insertion of wooden stakes or some other suitable termite bait material into the soil around the periphery of the structure to be protected, monitoring the stakes for infestation, and then applying a toxicant to the soil only in those areas in which infestation is observed. This approach minimizes use of the toxicant, yet presents other problems. The bait stakes, for example, do not provide a continuous barrier around the structure, as they typically occupy limited area and, moreover, are separated from one another by a distance on the order of feet or even yards. Termite populations located in the soil can have difficulty locating the bait stakes in the first place, especially if the bait stakes are widely spaced and located on a predetermined interval irrespective of conditions around a structure conducive to termite attack, such as moist areas around a structure. Also, removal of the bait stakes can disrupt the system of passageways leading to the stake that termites may have constructed and, in turn, can disrupt the flow of termites to the stake upon stake re-insertion. These problems are said to be addressed by U.S. Pat. Nos. 5,329,726 and 5,555,672, both in the name of Thorne, et al., which disclose insertion into the ground of a stationary housing that not only contains a removable bait cartridge but also possesses a plurality of extensions which are said to intercept or obstruct the path of termites in the vicinity of the housing.

More recent developments have focused on the need to further minimize disturbance to termites feeding within a termite station. U.S. Pat. No. 5,950,356 discloses an apparatus and method wherein a non-toxic termite bait is fixedly attached to the sidewall of a housing and, upon inspection of the sidewall of the housing for termite activity, toxic bait is introduced into the interior of the housing. This method is said to avoid the disturbances inherent in the use of a system of interchangeable monitoring and bait cartridges. U.S. Pat. No. 6,016,625 is said to disclose bait stations that contain a combination of stacked monitoring and baiting devices having an extractor means that can selectively move the termite monitoring and/or baiting devices.

The recent developments in the art require frequent inspection of the termite monitoring and baiting systems being employed. Typically, this inspection is carried out at designated time intervals by a Pest Control Operator (PCO). The PCO will often encounter different termite infestation situations from site to site, and may require flexibility in addressing each situation. For example, some sites may encounter heavy termite feeding. If the feeding substrate is consumed before the end of one of the PCO's inspection intervals, termites will have likely moved on from that location and controlling activities cannot be implemented at that site. Each time a PCO must go to a site for inspection requires the expenditure of time and money.

Despite the availability of current termite monitoring and baiting systems, it will be appreciated from the foregoing that there exists a need in the art for systems that offer a PCO various options for monitoring and controlling termites that cause little disturbance to the termites feeding in the station. In addition, there is a need in the art to extend the inspection time interval required for a PCO to implement monitoring and/or controlling activities.

### SUMMARY OF THE INVENTION

In one aspect, the present invention provides arthropod monitoring stations that comprise a housing having a first end, a second end, and a lateral wall extending between the first end and the second end. In such stations, the first end, second end, and lateral wall substantially define an interior portion of the housing, and at least one of the first end, the second end, and the lateral wall includes at least one aperture suitable for ingress or egress by an arthropod with respect to said interior portion of said housing. Preferably, at least two members are disposed within the housing, each of the members having a first end, a second end, and a lateral wall extending between the first end and the second end. In certain embodiments of the present invention, each of the members is disposed within the housing such that said lateral walls thereof are substantially parallel to each other and to the housing's lateral wall. It is preferred that at least one of the members comprises a material capable of being consumed by arthropods, a material capable of being penetrated by arthropods, a material capable of being transported by arthropods, or a material capable of killing arthropods.

In another aspect, the present invention provides arthropod monitoring stations that comprise a housing having a first end, a second end, and a lateral wall extending between the first end and the second end, wherein the first end, second end, and lateral wall substantially define an interior portion of the housing. In such stations, at least one of the first end, second end, and lateral wall includes at least one aperture suitable for ingress or egress by an arthropod with respect to the housing's interior portion, and there is disposed within the housing a material that is capable of being consumed by arthropods.

In yet another aspect, at least a portion of the first end element of the arthropod monitoring system housing is removably attached to the lateral wall of the housing and includes a locking mechanism.

The present invention also provides methods for either partially or completely implanting arthropod monitoring stations in soil. In preferred embodiments, such methods comprise the steps of identifying a building suspected to suffer from arthropod infestation and then implanting one or more stations at locations proximate to the building.

Also provided are methods for monitoring the stations of the invention for arthropod activity. Such methods comprise, for example, visually inspecting the station, looking inside the housing, and/or looking inside one or more of the members, and can further include adding and/or replacing members.

### BRIEF DESCRIPTION OF THE DRAWINGS

The foregoing summary, as well as the following detailed description of the preferred embodiments, is better understood when read in conjunction with the appended drawings. For the purpose of illustrating the invention, the drawings show certain preferred embodiments. It is understood, however, that the invention is not limited to the specific methods and devices disclosed. In the drawings:

FIG. 1a shows a perspective view of a monitoring station according to the present invention and FIG. 1b shows a perspective view of one exemplary locking mechanism.

FIG. 2 shows an isometric, cross sectional view of the station of FIG. 1a.

FIG. 3 shows an alternative perspective view of the station of FIG. 1a.

FIG. 4 shows a perspective view of a housing according to the present invention having members disposed therein

FIG. 5 shows an isometric, cross sectional view of the housing of FIG. 4 having guide cups therein.

FIG. 6 shows a perspective view of a housing according to the present invention having guide protrusions disposed therein.

FIG. 7 shows perspective views of representative combinations of members according to the present invention.

FIG. 8 shows perspective views of representative combinations of members according to the present invention.

FIG. 9 shows a perspective view of a housing according to the present invention having members disposed within a cylindrical block.

FIG. 10 shows a perspective view of a housing according to the present invention having members disposed within a cylindrical plate.

FIG. 11 shows a perspective view of a housing according to the present invention having members disposed between a rectilinear plate having a Y-shaped cross-section.

FIG. 12 shows a perspective view of a monitoring station according to the present invention partially contained within an outer sleeve.

### DETAILED DESCRIPTION OF THE INVENTION

The present invention provides stations and methods for monitoring arthropods. As used herein, the term “monitoring” is intended to mean watching, inspecting, observing, or checking a person or thing, particularly an arthropod such as a termite. Thus, a device that enables its user to simply determine whether or not termites are present in an area of interest is deemed to be a monitoring device, irrespective of whether or not that device enables its user to perform some additional task such as, for example, killing the termites.

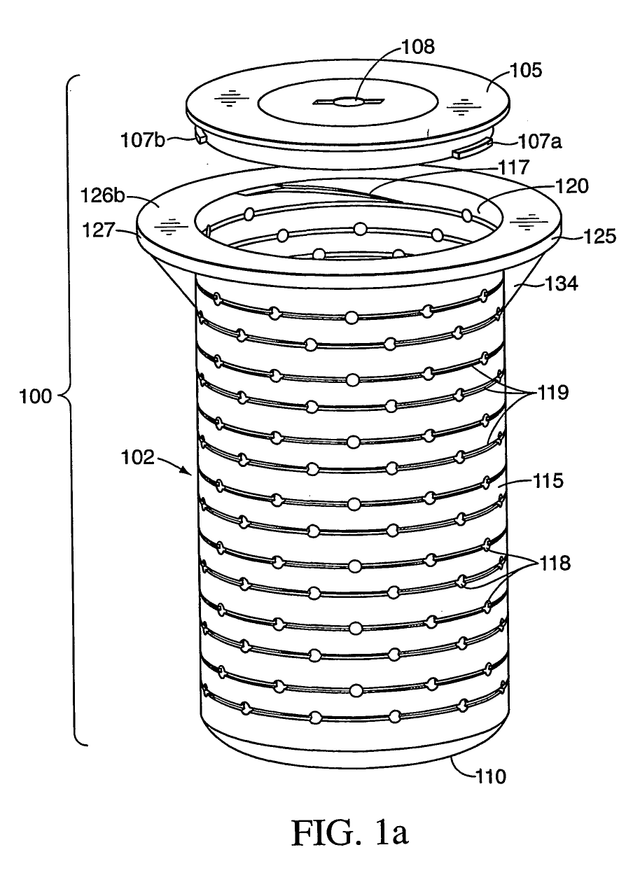

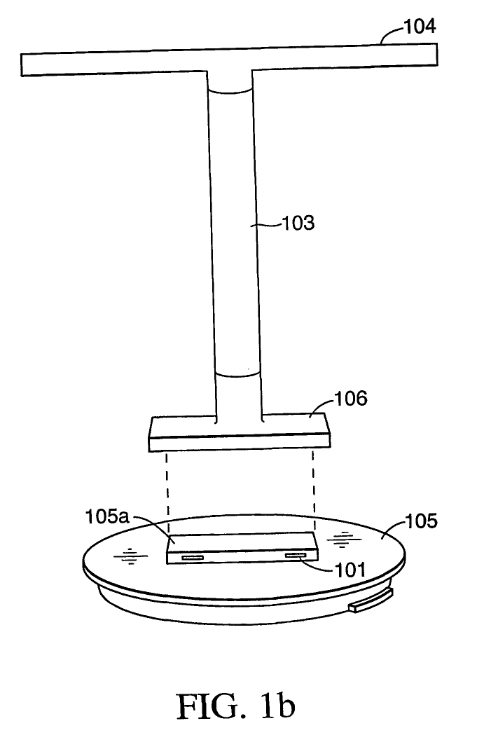

FIG. 1a shows a preferred arthropod monitoring station 100 according to the present invention comprising a housing 102 having a first end element 105, a second end element 110, and a lateral wall 115 extending between said first end element and said second end element. As shown in FIG. 1a, first end element 105, second end element 110, and lateral wall 115 substantially define an interior portion 120 of said housing, with at least one of the end elements (e.g., 105) being removably attached to lateral wall 115 so as to provide access to interior portion 120. Any of the known means for removable attachment can be used. The end element, for example, can snap or screw over or into the housing lateral wall. A preferred attachment means whereby end element 105 screws into lateral wall 115 using threaded elements 107 and 117 is shown in FIG. 1a. The attachment means can further include a locking mechanism, preferably a locking mechanism 108 that involves the insertion of a key (not shown) into end element 105 to enable removal thereof. The key can be inserted into mechanism 108 in a manner whereby element 105 can be lifted off housing 102 and not fall off of the key.

Another class of locking mechanisms involve inserting a portion of the end element into a cooperative member. As shown in FIG. 1b, one embodiment of such locking mechanism includes a protrusion 105a on end element 105 and a member 106 that conforms to at least a portion of the protrusion and, thereby, permits rotation of the end element. For example, member 106 may contain one or more protrusions (not shown) that are received in complementary recesses 101 in protrusion 105a.

Protrusion 105a and member 106 preferably have similar cross-sectional shapes, with member 106 typically being somewhat larger. Virtually any shape can be employed, although use of a closed surface shape is somewhat preferred relative to an open-surfaced shape. A substantially rectilinear protrusion 105a and member 106 is particularly preferred. As shown in FIG. 1b, member 106 can optionally be attached to a shaft 103 which, in turn, can optionally be attached to handle 104. A wide variety of shafts and handles can be used, including, for example, solid, hollow, and/or telescoping shafts. As will be recognized, one benefit of using an elongated shaft is to facilitate remote access to end element 105, such as, for example, to enable the user to engage the end element 105 from a standing position when the station 100 is implanted into the soil. Such a preferred embodiment provides ease of access to the interior of the station for inspection.

The locking mechanisms of the present invention can optionally include a bar code (such as used with Universal Product Codes (UPC)), and a bar code reader. Such a bar coding system can be employed, for example, to serve a quality control, inventory, or checklist function. For example, the bar code can include information such as the date of placement of the station, the number of times and/or dates on which the station has been inspected, modifications that have been made to the station, the number of stations at a particular location, and/or an identification code that is unique to each station.

Taking the embodiment illustrated in FIG. 1b as an example, a bar code (not shown) can be placed on the station, such as on the inside or outside of end element 105. A bar code reader (not shown) can be disposed on member 106 with a display member (not shown) attached to handle member 104. Such a bar code system is exemplary and each element of the bar code system can be employed on different elements of the station. Bar code systems are associated with numerous products, and those skilled in the art are aware of numerous ways to program and implement such a system in connection with the arthropod monitoring systems and methods disclosed herein, depending on the type of information desired. Information embodied in the bar code can, for example, be accessed by scanning the bar code with the reader or otherwise inputting information through an associated processor.

The end elements and lateral wall can be fabricated from any of a variety of materials having suitable strength and rigidity including, without limitation, plastic (i.e., synthetic polymer), wood, plaster, concrete, asphalt, tile, brick, masonry, ceramic, metal, rigid polymeric foam, composites of two or more materials, and laminates of suitable sheet materials. It is preferred that they be fabricated from rigid or flexible plastic, preferably polyethylene or polystyrene, and more preferably polypropylene. The end elements and lateral wall can be pressed, molded, extruded, or otherwise formed from several parts. For certain applications, it is desired to form at least a portion of the end elements and/or the lateral wall from a transparent material such as glass or synthetic polymer to facilitate inspection of interior portion 120.

Housing 102 should have a lateral cross-section (i.e., a cross section taken perpendicular to lateral wall 115) that defines a closed surface shape such as, for example, a circle (as, for example, in FIG. 1a), triangle, tetrahedron, pentagon, hexagon, heptagon, octagon, or more complex polygon. End elements 105 and 110 will typically have corresponding shapes, and preferably are either substantially in the form of a plate or have a somewhat more tapered, conical structure.

Although monitoring station 100 need not have any particular dimensions, end elements 105 and 110, independently, will typically each have a diameter of about 2 to about 10 inches and lateral wall 115 will typically be from about 4 to about 25 inches long. Preferably, end elements 105 and 110 have approximately the same diameter and lateral wall 115 has a length that is from 2.0 to 2.5 times that diameter. In a particularly preferred embodiment, end elements 105 and 110 both have a diameter of about 4.5 inches and lateral wall 115 is about 9 inches long.

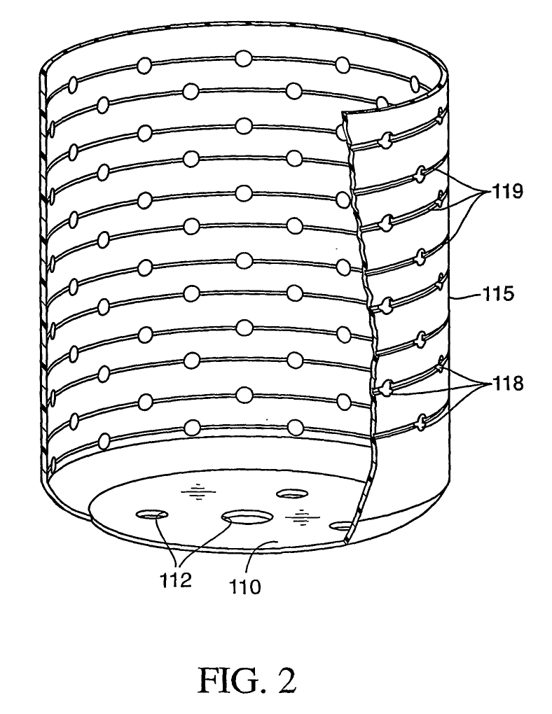

In certain embodiments of the present invention, at least one of end elements 105 and 110 and lateral wall 115 includes at least one aperture suitable for ingress or egress by an arthropod with respect to interior portion 120 of the housing. In preferred embodiments, such as shown in FIGS. 1 and 2, there are a plurality of apertures 118 in lateral wall 115 and a plurality of apertures 112 in end element 110. In accordance with the present invention, a baiting material can be inserted into one or more of apertures 112 such that the baiting material extends into interior portion 120 and into a monitoring region adjacent (preferably, beneath) station 100 in which the presence of the arthropods is suspected. The baiting material can be any material that encourages insect infestation, and through which or around which insects can travel. In certain embodiments, the baiting material is one that is capable of being moved, transported, tunneled into, or ingested by insects. Preferably, baiting material includes or, together with a wall of aperture 112, forms an opening (e.g., a pore or hole) through which insects can travel. In alternative preferred embodiments, baiting material includes a material through which insects can tunnel. Exemplary baiting materials include, but are not limited to, cellulosics (e.g., wood and cardboard), synthetic polymers (such as polystyrene foam), topsoil, and sand. These materials can have a variety of shapes, including dowels having holes drilled through their bodies or slots scored along their edges, rolled cardboard, blocks of wood, hollow cylinders, bundles of wood pieces, bundles of drinking straws, pellets, or powders (e.g., sawdust). The baiting material also can bear a coating of a material that insects ingest (such as a sugar or protein), an attractive pheromone, or water. A preferred and economical baiting material is a slotted dowel. As used herein and unless otherwise indicated, the term “dowel” should be read to include, without limitation, a rod of wood, synthetic polymer, metal, foam, and any other similar material.

Alternatively, a material not penetrable by termites can be inserted into aperture 112, reach into interior portion 120, and be inserted into soil beneath station 100. Termites can locate the material and follow it into interior 120 and feed upon bait therein. Preferred non-penetrable materials are plastic objects with a plus sign (e.g., +) shaped cross-section and/or those that extend up to about 24 inches beneath station 100.

As shown in FIG. 1a, apertures 118 in lateral wall 115 preferably are disposed in offset horizontal rows to form a triangulated pattern. The apertures are typically 0.25 inches in diameter, but may be varied. The separation distance between any two apertures is from about 0.25 inches to about 2.0 inches, and preferably about 0.50 inches, measured from the edge of an aperture. It is particularly preferred that lateral wall 115 include substantially rectilinear grooves 119 that each connect apertures falling within a given row. Such grooves should have approximately equal depth and width, preferably about 1/8 inch each. Alternatively, the lateral wall can include substantially rectilinear raised ridges (not shown) that each connect apertures falling within a given row. Such ridges should have approximately equal width and height, preferably about 1/8 inch each.

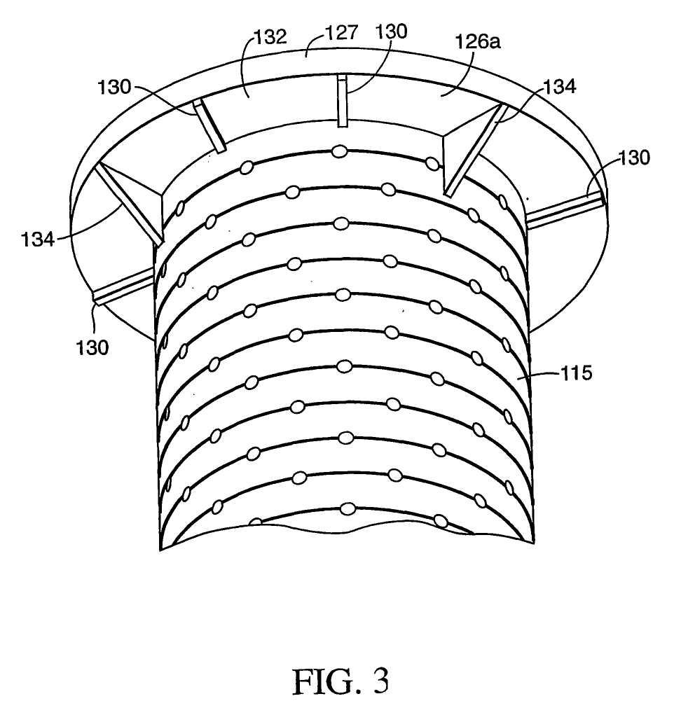

It is also preferred that lateral wall 115 be surrounded generally at one of its ends with a collar element 125. Collar element 125 can be integral with lateral wall 115, as shown, for example, in FIG. 1a, or can be an entirely separate structure. As shown in FIGS. 1 and 3, collar element 125 has a first face 126a and a second face 126b substantially opposite first face 126a. Preferably, collar element 125 has a diameter of about 7 inches and a thickness (i.e., distance between first face 126a and second face 126b) of about 0.06 inches to about 6 inches. In the embodiment shown in FIGS. 1 and 3, first face 126a and second face 126b both are substantially planar and parallel, although they need not be. Collar element 125 has a containment ridge 127 between first face 126a and second face 126b. Containment ridge 127 protrudes from first face 126a along at least a portion of the outer edge of collar element 125 and defines the outer periphery of a containment region 132 proximate first face 126a. In preferred embodiments, collar 125 also has a plurality of guide ridges 130 that protrude from first face 126a and further define at least one containment region 132. Guide ridges 130 can be of virtually any size and shape, so long as they protrude from first face 126a. Representative collar elements according to the present invention include the arthropod containment devices disclosed in U.S. patent application Ser. No. 09/165,841, filed on Oct. 2, 1998 (WO 00/19816, published Apr. 13, 2000), the contents of which are incorporated herein. While not wishing to be limited to any particular theory, guide ridges 130 are believed to direct arthropods along containment regions 132 toward station 100. Each of containment ridge 127 and guide ridges 130 has a width and protrudes a distance from first face 126a. Their respective widths preferably are about 0.03 inches to about 0.5 inches, and they preferably protrudes about 0.1 inches to about 0.6 inches from first face 126a.

Stations according to the invention preferably also include one or more external protrusions to minimize transverse rotation of the station after it is implanted in the ground. In general, the extent of such minimization is directly proportional to the number and size of the protrusions. One representative type of protrusion, shown in FIGS. 1 and 3, is a vane 134 abutting both lateral wall 115 and first face 126a.

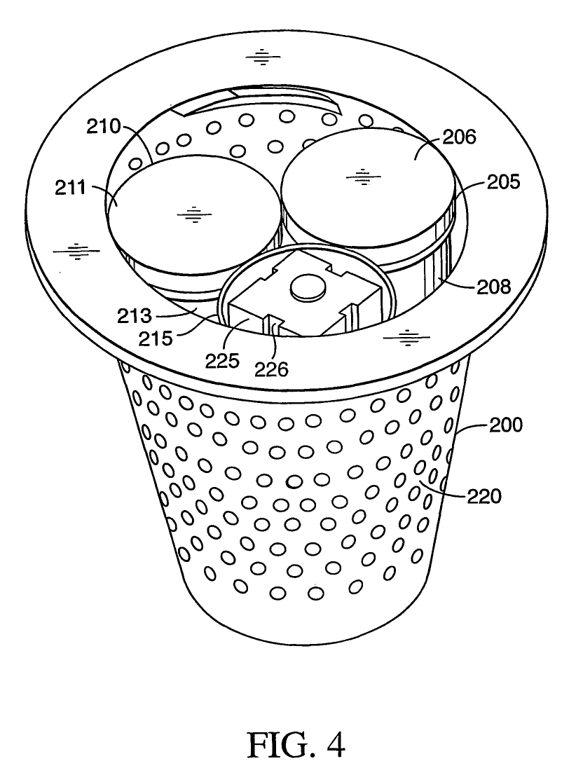

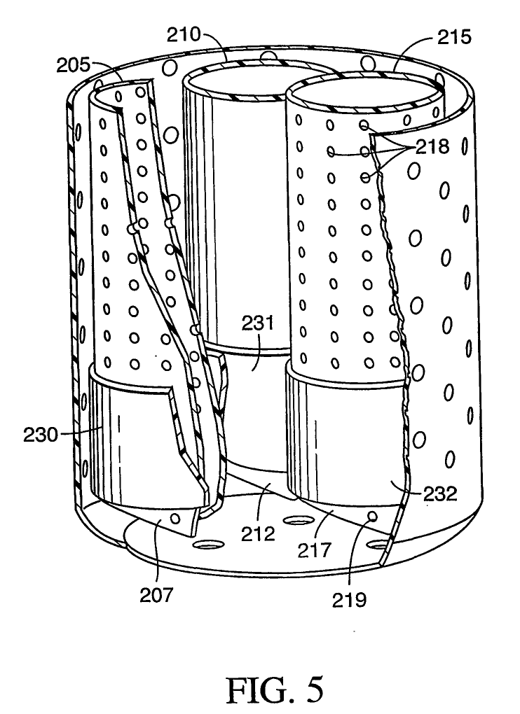

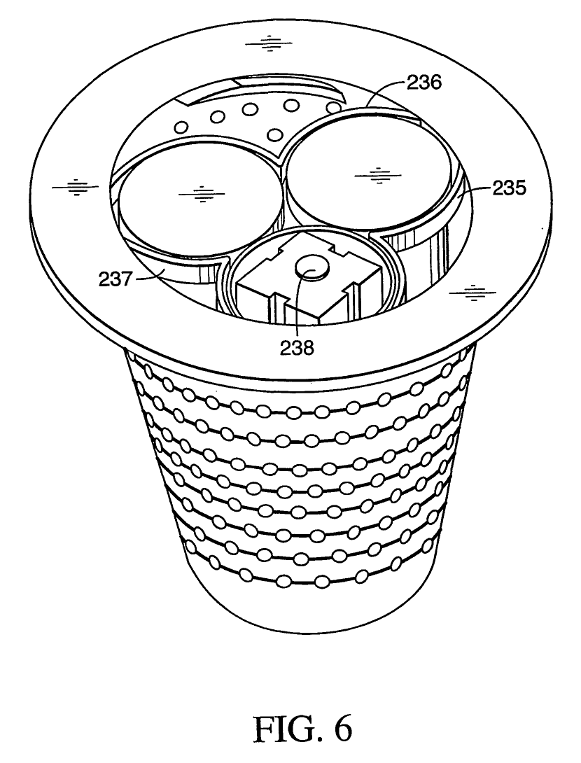

The stations of the invention preferably include at least two members removably positioned within the above-noted housing. FIGS. 4 and 5 show a representative housing 200 of the invention with three members 205, 210, 215 therein. As exemplified by member 205, members according to the invention can include a first end element 206, a second end element 207, and a lateral wall 208 extending between the first end element and the second end element. Optionally, the end elements may have a small opening to release moisture from within the member. In addition, end elements or the members themselves may have a gripping element (238, FIG. 6) to facilitate removal of a member from the housing or material contained within a member from the member. The gripping element may include a nail, knob, or molded protrusion. As exemplified by member 215, members according to the invention need not include end elements and, thus, can be open-ended.

As shown in FIG. 4, each of members 205, 210, and 215 is disposed within housing 200 such that the lateral walls (e.g., 208 and 213) of the members are at least substantially parallel to each other and to lateral wall 220 of housing 200. Alternatively, apertures 112 can be enlarged to orient members 205, 210, and 215 without the use of guide cups. The term “substantially parallel,” as used herein, is intended to refer to positioning two structures such that their respective longitudinal axes (as, for example, defined by lateral walls 208 and 220) either do not meet or meet to form an angle no greater than 45°. One preferred means for maintaining members in a substantially parallel configuration is to provide suitably shaped structure on the interior of housing 200. Representative structures, as shown in FIG. 5, are guide cups 230, 231, and 232 adapted to receive at least a portion (e.g., end elements 207, 212, and 217) of members 205, 210, and 215. These guide cups can each be integral with housing 200, can be integral with each other with one of them (e.g., 230) integral with housing 200 (as shown), or can each be integral with the housing and with each other. Alternative structures, shown in FIG. 6, are guide protrusions 235, 236, and 237. These protrusions preferably conform to one or more members along at least a portion of their respective lateral walls. Guide protrusions can also provide a means for directing arthropods to members after entering a housing. Where such protrusions are employed, they preferably include at least one aperture that permits ingress or egress of an arthropod.

Members according to the invention are formed from and/or contain materials capable of being consumed by arthropods, materials capable of being penetrated by arthropods, materials capable of being transported by arthropods, and/or materials capable of killing arthropods. Representative materials capable of being consumed by arthropods include cellulosic materials such as wood, cardboard (with or without wax treatment), fiberboard, paper, and sawdust. Typically, materials capable of being consumed by arthropods, as used herein, refer to materials that are not toxic, i.e. not capable of killing arthropods. Preferred materials of this type include wood and sawdust. In other embodiments, the material capable of being consumed by termites comprises a composition as disclosed in U.S. Pat. No. 5,573,760, which is incorporated herein by reference in its entirety. Representative materials capable of being penetrated by arthropods include polymeric foams such polystyrene foam, chalk, sponge material, and wood. Representative materials capable of being transported by arthropods include polyurethane and chalk. Representative materials capable of killing arthropods include but are not limited to, slow acting toxicants such as sulfluramid, hydramethylnon, avermectin, spinosad, imidacloprid, fipronil, chlorfenapyr, indoxacarb, borates, insect growth regulators, chitin inhibitors (such as hexaflumuron and diflubenzuron), halofenicide, isothiozalone, sulfotine, juvenile hormone analogs, biological agents (e.g., spores, mycelium, or toxins), pyrethroids, protazoacides, and anti-bacterial agents. Preferred materials include sulfluramid and sulfotine. Members of the invention can be formed entirely from such materials (as, for example, in the case of a wooden block), can be formed partially from such materials (as, for example, in the case of a wooden box or tube, or a fibreboard in which a granular material capable of killing arthropods is dispersed), or can simply include such materials (as, for example, in the case of a plastic tube filled with cardboard).

The end elements and lateral walls of members according to the invention can be formed from any material having suitable strength and rigidity. In embodiments in which the member is monolithic (as with block 260), its end elements and lateral wall will be formed from one of the materials capable of being consumed by arthropods, capable of being penetrated by arthropods, capable of being transported by arthropods, and/or capable of killing arthropods. In other embodiments, in which the lateral wall and/or the end elements define an interior portion of the member (as with capped tube 205), one or more of the end elements and lateral wall can be formed from any material having suitable strength and rigidity including, without limitation, plastic (i.e., synthetic polymer), wood, plaster, concrete, asphalt, tile, brick, masonry, ceramic, metal, rigid polymeric foam, composites of two or more materials, and laminates of suitable sheet materials. It is preferred that they be fabricated from rigid or flexible plastic, preferably polypropylene. The end elements and lateral wall can be pressed, molded, extruded, or otherwise formed from several parts. For certain applications, it is desired to form at least a portion of a member's end elements and/or lateral wall from a transparent material such as glass or synthetic polymer to facilitate inspection of its interior portion.

Members according to the invention should have a lateral cross-section (i.e., a cross section taken perpendicular to, for example, lateral wall 208) that defines a closed surface shape such as, for example, a circle (as, for example, in FIG. 4), triangle, tetrahedron, pentagon, hexagon, heptagon, octagon, or more complex polygon. End elements will typically have corresponding shapes, and preferably are substantially in the form of a plate (e.g., 206) or have a somewhat more tapered, conical structure (e.g., 207). Preferred members according to the invention include monolithic rectilinear blocks (e.g., 225), cylindrical monolithic blocks, and cylindrical tubes (e.g., 205). Particularly preferred monolithic blocks are those that include at least one substantially rectilinear groove (e.g., 226) on its lateral wall, preferably along substantially the entire length of its lateral wall. Such grooves should have approximately equal depth and width, preferably about 1/8 inch each.

Members having interior portions can have permanently affixed end elements or removably attached end elements. Any of the known means for permanent affixation or removable attachment can be used. End element 211, for example, can be glued or otherwise bonded to lateral wall 213. Alternatively, an end element can removably snap or screw over or into the housing lateral wall. A preferred means for removable attachment is one in which end element 206 snaps over lateral wall 208, as shown in FIG. 4.

A member (e.g., 215) having an interior portion can further include one or more apertures (e.g., 218) disposed in its lateral wall, or one or more apertures (e.g., 219) disposed in one of its ends. Such members typically include in their interior portion one or more of the materials capable of being consumed by arthropods, capable of being penetrated by arthropods, capable of being transported by arthropods, and/or capable of killing arthropods. The interior portion of such a member can further include water (and, optionally, a gelling agent to retain the water) or a device that emits a signal when an arthropod is present within the interior portion of the housing.

As will be recognized, there are a variety of members that can be used in accordance with the present invention. Particularly preferred members include the following:

i. a substantially cylindrical wooden block having flat end elements

ii. an empty, substantially cylindrical plastic tube having a conical end, and a flat end cap;

iii. an empty, substantially cylindrical perforated plastic tube having a perforated conical end, and a removable flat end cap;

iv. a substantially cylindrical perforated plastic tube having a perforated conical end, a removable flat end cap, and a material capable of being consumed by arthropods in its interior portion;

v. a substantially cylindrical perforated plastic tube having a perforated conical end, a permanently-affixed flat end cap, and a material capable of killing arthropods in its interior portion;

vi. a substantially cylindrical perforated plastic tube having a perforated conical end, a removable flat end cap, and water (and, optionally, a gelling agent) in its interior portion.

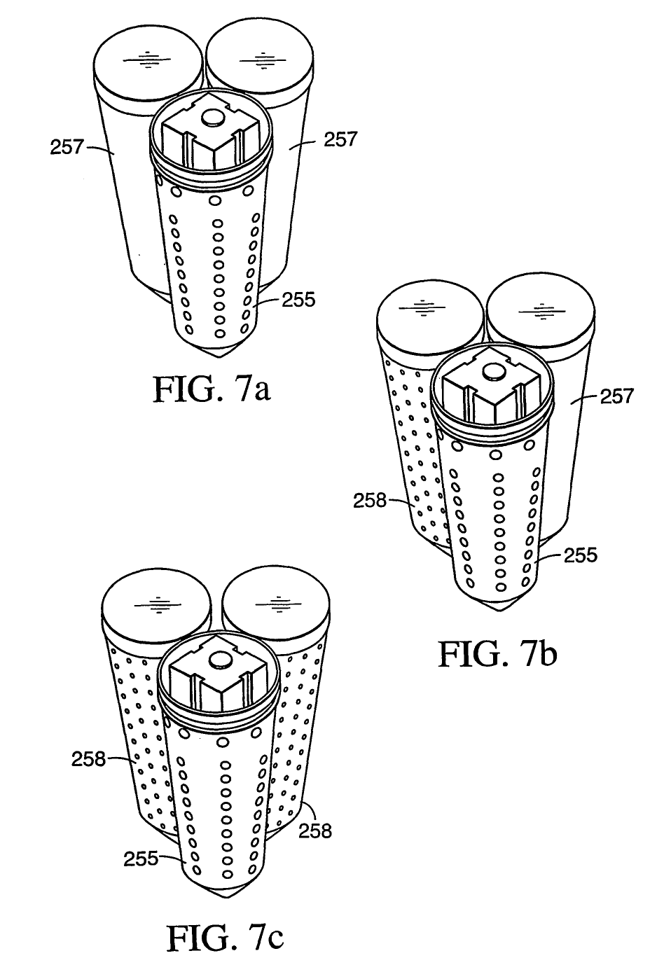

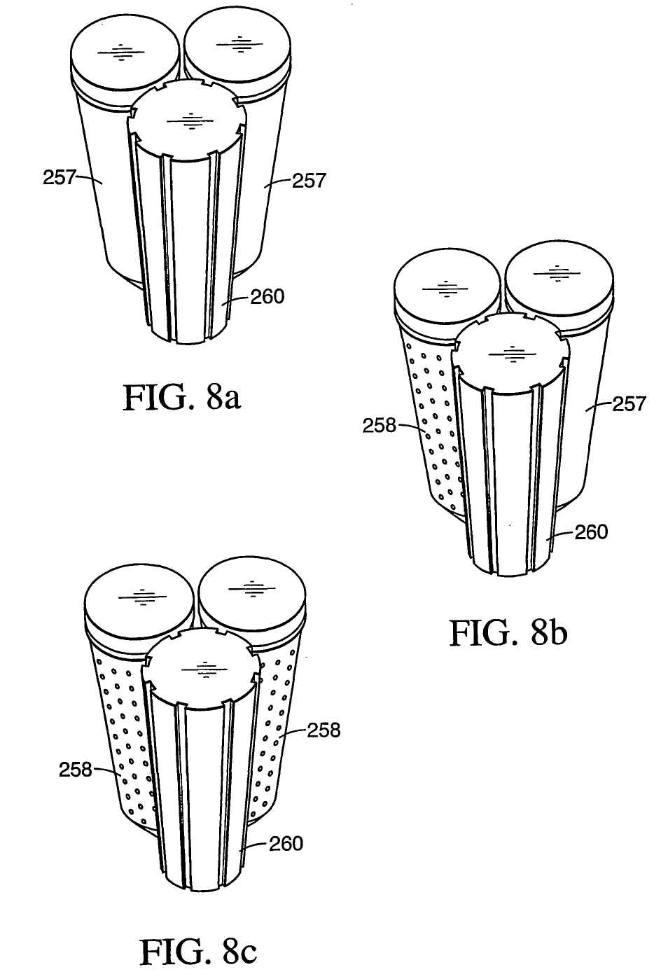

There are, thus, quite a number of possible ways of combining these and other members in a housing in accordance with the present invention. As shown in FIG. 7a, for example, one can combine two members of type ii (257) with a member of type iv (255). Alternatively, one can combine a member of type iv (255) with a member of type ii (257) and a member of type v (258) (as in FIG. 7b), or a member of type iv (255) with two members of type v (258) (as in FIG. 7c). One can also combine a member of type i (260) with two members of type ii (257) (as in FIG. 8a), a member of type i (260) with a member of type ii (257) and a member of type v (258) (as in FIG. 8b), or a member of type i (260) with two members of type v (258) (as in FIG. 8c). In other embodiments, members of type iii and type vi may also be used in place of one or more other types of members or in addition to one or more other types of members. A member of type vi may provide moisture to the interior of the housing. These combinations can be achieved independently by, for example, removing all of the members in a station and then replacing them with entirely different members, or through a more transitional process by, for example, removing and replacing only one of three members.

In embodiments in which wood blocks are employed in a housing, either as members (as shown, for example, in FIG. 8a) or within members (as shown, for example, in FIG. 7a) it is preferred that the wood used be of a type and amount that arthropods to which the station is exposed are not able to entirely consume the wood within about 90 days. The amount of wood that needs to be used to satisfy this requirement will typically be at least 50-100 grams, more preferably at least 200 grams. In other embodiments, 500-600 grams of wood may also be used depending on the type and amount of arthropod infestation. Preferred types of wood include spruce, southwestern pine, and aspen birch.

Depending on the respective shapes of the housing and the members, the interior of the housing can comprise empty space between the members and the housing, as well as between the members themselves. In some embodiments, it is preferable to partially or completely fill this space to, for example, provide points of contact with the housing and the members that enable the arthropods to travel between the housing and the members and from member to member. Another reason for filling this space is to provide support for the members disposed within the housing and to maintain the members in a substantially parallel configuration. The material used to fill the housing can be disposed between the housing and one or more of the members or just between the members themselves. Representative filling materials include those capable of being consumed by arthropods, capable of being penetrated by arthropods, capable of being transported by arthropods, and/or capable of killing arthropods. Preferred filling materials include wood, cardboard, paper, polymeric foam (including expanded and/or extruded polystyrene foam), polyethylene and/or any of these materials optionally treated with a substance capable of killing arthropods. In addition, the filling material may comprise a composition as disclosed in U.S. Pat. No. 5,573,760, that may be placed in the interior of the housing and/or at the bottom of end element 110. These materials can be in any of a variety of shapes, including without limitation powders, flakes, chips, sticks, slats, and dowels.

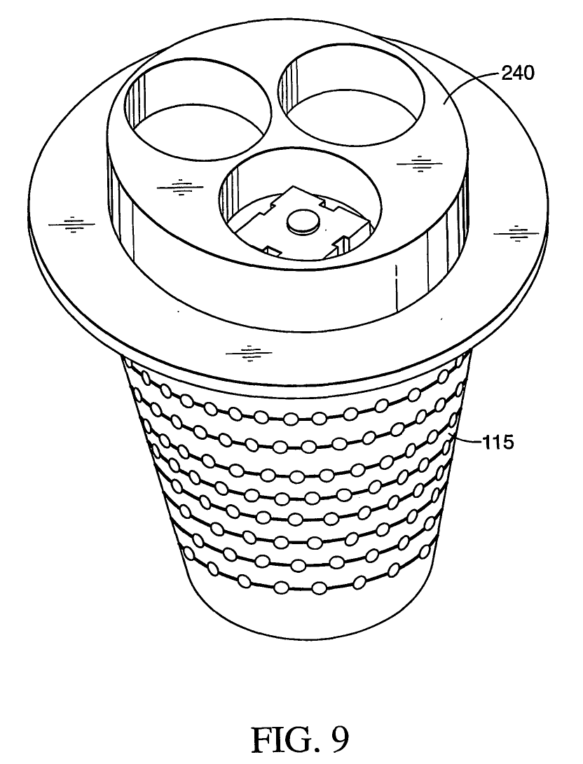

In one embodiment shown in FIG. 9, the filling material is in the form of a substantially monolithic mass 240. As shown in FIG. 9, monolithic mass 240 can conform to the lateral wall of the housing 115 as well as the lateral walls of the members. In other embodiments, the monolithic mass conforms to a portion of the lateral wall of the housing and one or more lateral walls of the members. As will be recognized, monolithic mass 240 is generally in the form of a cylindrical block. Preferably, the monolithic mass comprises a material capable of being penetrated by arthropods, consumed by arthropods, or transported by arthropods, and more preferably comprises a material capable of being penetrated by arthropods, such as a polymeric foam, and provides support for one or more members disposed within the housing. The monolithic mass can have a length equal to the length of the lateral wall of the housing or members or can only conform to a portion of the length of the lateral wall of the housing or members. Preferably, the monolithic mass has a length of at least about 66% of the length of the lateral wall of the housing.

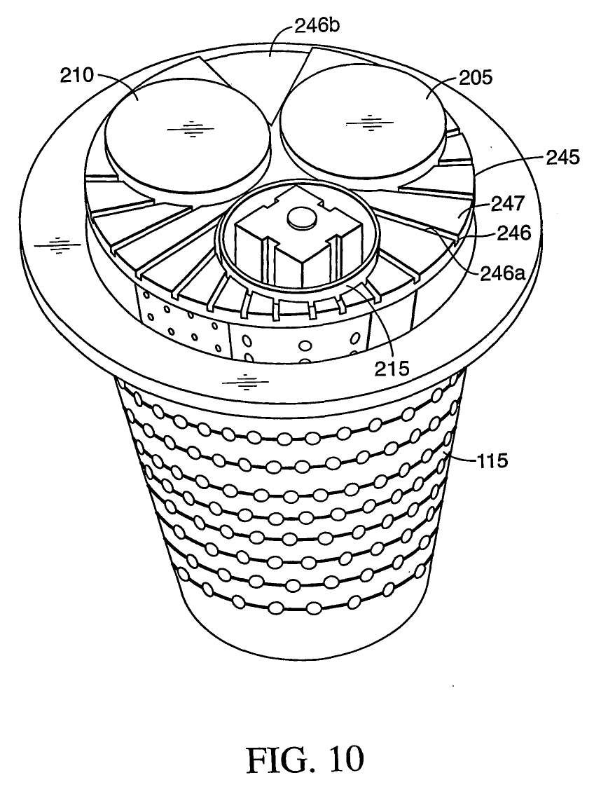

In another embodiment shown in FIG. 10, the filling material is substantially in the form of at least one plate 245 having a thickness that is less than about 1.0% of the length of the lateral wall 115 of the housing. As will be recognized, multiple plates can be used. As shown in FIG. 10, the plate has at least a first face 247 and a second face (not shown) substantially opposite first face 247. Preferably, the plate 245 has a diameter of about 4.5 inches. In the embodiment shown in FIG. 10, first face 245a and second face (not shown) both are substantially planar and parallel, although they need not be. One or more of these plates can be located at various points along the length of the housing, such as at the ends or the middle of the housing. If specific location of plate 245 is desired, the plates may be affixed to the lateral wall 115 of the housing in any conventional manner. For example, the outer edge of the plate 245 may be glued, integrally molded, clipped or nailed to the lateral wall 115 of the housing. Alternatively, the plates may be supported by protrusions extending from the lateral wall 115. In embodiments involving multiple plates, a spacer element may be inserted between plates 245 to prevent the plates from compacting on one another. In these embodiments, the spacer element may contact the first face of one plate and the second face of another plate. The spacer element may be affixed to the lateral wall 115 in the same manner as the plate 245 and may be made of the same material as the plate 245.

As shown in FIG. 10, the plate or plates can conform to at least a portion of members 205, 210, and 215 and/or at least a portion of the lateral wall 115 of the housing. In addition, the plate or plates can provide support for the members disposed within the housing and help maintain the members in a substantially parallel configuration. In certain embodiments, the plate is formed from a synthetic polymer that is resistant to arthropod consumption. The plate can also comprise a material capable of being penetrated by arthropods, such as a polymeric foam.

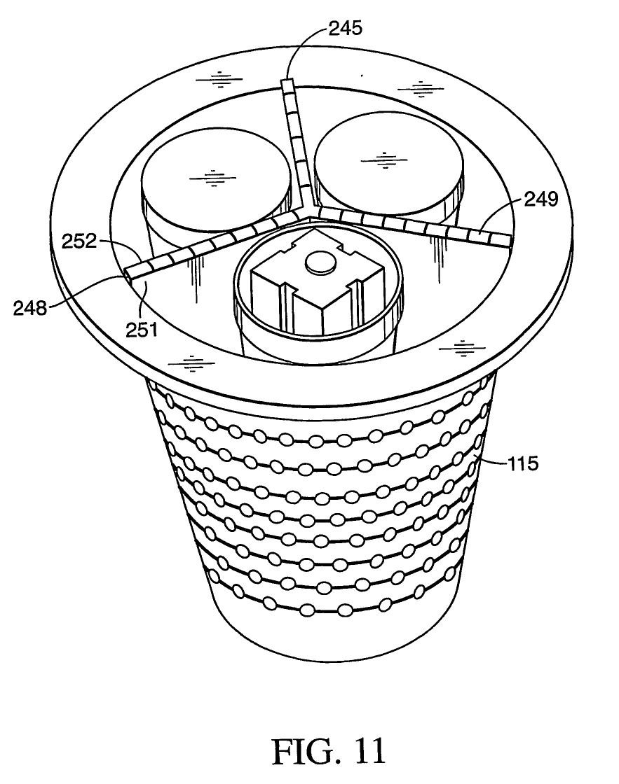

As shown in FIG. 11, one or more plates 245 can be disposed between the members. The plates can have a length equal to or somewhat less than the length of the lateral wall of the housing and/or members. Preferably, plate 245 has a length of at least about 66% of the length of the lateral wall of the housing. In the embodiment shown in FIG. 11, the plate is substantially rectilinear, but can have a variety of other shapes. As shown, the plate has a Y-shaped cross-section accommodating three (or more or fewer) members. The plate can, of course, have a different cross-section, such as one that has an X-shape so as to accommodate four (or more or fewer) members. The shape and cross-section of the plate can vary depending on the number of members utilized and/or the application desired. As shown in FIG. 11, outer edge 248 between faces 251 and 252 of plate 245 conforms to the lateral wall of the housing 115. These faces can have one or more preformed pores or openings through which arthropods may travel. Alternatively (and as shown), faces 251 and 252 have no openings. Plates of the type shown in FIG. 11 can be constructed from a corrugated or solid material such as wood, cardboard, paper, polymeric foam (including expanded and/or extruded polystyrene foam), polyethylene, plastics, or other synthetic polymers. Preferably, plate 245 is constructed from a corrugated synthetic polymer having substantially hollow passageways 249 extending substantially throughout the plate's length.

In preferred embodiments, the plate or plates comprise a plurality of grooves 246 on a surface of the first and/or second face (not shown) of plate 245. These grooves 246 define at least one containment channel 246a. The grooves 246 can be of virtually any size and shape. While not wishing to be limited to any particular theory, the grooves 246 are believed to direct arthropods along containment channels 246a toward the members as well as from the members to the lateral wall 115 of the housing. The widths of the grooves preferably are about 0.03 inches to about 0.5 inches, and more preferably about 0.125 inches.

The grooves (and, hence, the containment channels they define), may, for example, be of similar dimensions along their entire length, as with channel 246a, or may narrow (as with a slice of a pie) as one proceeds from the lateral wall 115 of the housing to the members, as with channel 246b.

Alternatively, the plate 245 may comprises a plurality of ridges on a surface of the first and/or second face (not shown) of plate 245. These ridges may define at least one containment channel. The ridges can be of virtually any size and shape. While not wishing to be limited to any particular theory, the ridges are believed to direct arthropods along containment channels toward the members as well as from the members to the lateral wall 115 of the housing. The widths of the ridges preferably are about 0.03 inches to about 0.5 inches, and more preferably about 0.125 inches.

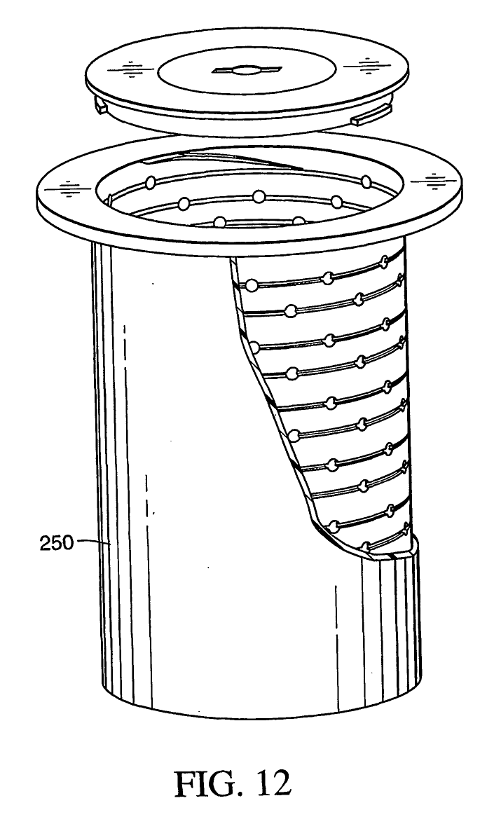

In further embodiments, the stations of the present invention comprise one or more sleeves, either inside or outside the housing. Referring to FIG. 12, sleeve 250 can substantially conform to the exterior of lateral wall 115 of housing 200. Alternatively, a sleeve can substantially conform to the exterior of one or more of the members disposed within the housing. The sleeve can be formed of material capable of being consumed by arthropods, capable of being penetrated by arthropods, capable of being transported by arthropods, and/or capable of killing arthropods. Preferably, the sleeve does not contain preformed openings to the housing 200 and/or to the members. Instead, the openings or tunnels through the sleeve 250 are formed by the arthropods themselves. Preferably, the sleeve 250 has a thickness that is less than about 3.0% of the length of the lateral wall 115 of the housing.

As evident from the disclosure herein, the present invention provides a PCO or other operator with various alternatives to monitor and/or control an arthropod population. The various members that can be disposed within the housing provide an operator with increased flexibility in treating any particular arthropod infestation situation. The use of multiple members also make it possible to provide a relatively large volume of monitoring and/or baiting material in response to heavy feeding conditions that will allow inspections to be conducted at extended intervals to save both time and money. Moreover, the separate and independent configuration of the multiple members within the housing and the various functions each member can serve provide many alternatives for minimizing interruption and disturbance of arthropod feeding within the housing starting at the time of station installation and throughout the monitoring and/or controlling activities.

Generally, one or more stations 100 are implanted in the soil, although such stations can be adapted for above-ground use. Typically, the station or stations are implanted in the soil within about 1-2 feet of a building, preferably one suspected of suffering from arthropod infestation. If two or more stations are implanted, the stations are generally located within 10 feet of one another.

In one embodiment, the station is implanted in the soil such that a portion of the lateral sidewall 115 of the housing extends above the soil. Typically, the lateral sidewall will extend to such a point above the soil that a PCO or other operator can locate the station and access the station without having to disrupt its position in the soil. At the same time, the extension preferably is not at a height that would cause interference with a lawnmower or other above-ground devices. Upon locating a station, a PCO operator should be able to manipulate one of the end elements (e.g., 105) that is removably attached to lateral wall 115 so as to provide access to the interior portion 120 of the housing. Preferably, an operator may remove the end element 105 by utilizing the locking mechanism depicted in FIG. 1b. For example, an operator, from a standing position, may engage protrusion 105a with cooperative member 106, thereby allowing the end element to be rotated and removed. The end element 105 may remain attached to the cooperative member 106 after removal due to engagement of protrusions on the cooperative member 106 (not shown) and recesses 101 of protrusion 105a to allow for easy replacement after inspection of the interior of the station is complete.

In general, the stations of the invention will be initially inspected for arthropod activity, especially in areas where arthropods have not previously been detected. Accordingly, to the extent a member has an interior portion, end elements 211 of such members within the housing preferably are transparent to allow inspection of the interior without disruption of the member. Alternatively, the end element, such as 211, of the members can be removed from the lateral wall of the member to inspect the interior of the member. When there is termite activity in a member, it is preferable to avoid complete or partial removal of the member from the housing. In some embodiments, arthropod activity within the station will be evident from inspection of the material within the housing but exterior to the members, including inspection of monolithic mass 240, plate 245, protrusion 237, and/or sleeve 250.

Use of the stations of the invention is exemplified by reference to FIGS. 7 and 8. It is to be understood, however, that other combinations and selective placement and replacement of members is contemplated within the scope of the present invention, as the flexibility offered by the present invention is one of its advantages. Indeed, the members and materials can be disposed in any sequential arrangement in the housing and the configurations shown in the drawings are merely exemplary. Referring to FIG. 7, embodiments involving three members are depicted. Initially, it is preferred that a station of the invention comprise members that serve a monitoring function. For example, in FIG. 7a, member 255 includes a wooden block within a member and two placeholder members 257, i.e., members that have no openings and an empty or solid interior, preferably made of an arthropod resistant material. In alternative embodiments, member 255 may be combined with a member that can include water, pheromones, humectants, or other material attractive and/or nonrepellant to arthropods. Member 255 is periodically inspected for arthropod activity. Inspection is typically performed by inspecting for termite activity by looking through a transparent end element of the member or by removing a detachable end element of the member.

Upon detection of arthropod activity within the housing, and in particular within member 255, one or more placeholder members 257 can be removed and replaced with a member 258 having a material capable of killing arthropods in its interior, i.e. a baiting member (see, e.g., FIGS. 7b and 7c). Preferably, the end elements of baiting member 258 are permanently affixed to the lateral wall of member 258, particularly if the material capable of killing arthropods is hazardous to people and pets and/or if the material is otherwise deemed hazardous by environmental regulations or laws. In this manner, arthropods previously feeding or present within member 255 will be relatively undisturbed upon placement of a baiting member 258 within the housing to provide control of the arthropod population. In heavy infestation areas, two baiting members 258 can be inserted for two placeholder members 257 (FIG. 7c) or an additional baiting member, a fourth member, can also be disposed within the housing.

FIG. 8 depicts embodiments wherein a wooden block (260) is employed as a member. In other embodiments, a monitoring member 255 can be arranged with two placeholder members 257. Upon detection of arthropods in member 255, the wooden block is removed and arthropods are tapped back into the empty member 255. Although not wanting to be bound by any one theory, it is believed that the removed arthropods serve a recruitment function in that they will return to their nest and direct other arthropods to the station. The wooden block originally in member 255 may be discarded or placed in a new member 255 that can be used to replace a placeholder member 257.

In addition, the station housing can initially contain one or more baiting members 258, particularly if detection is not a primary concern or if an area is known to be infested with arthropods. As is evident from the above examples, the members of the invention can be arranged in various combinations and substituted for one another depending on the particular arthropod infestation situation. The substitution of a member or the insertion of a member can be carried out without substantial disturbance to the arthropods already present within the station housing, especially with the use of placeholder members 257. In addition, the removal and/or insertion of one member can take place without disturbance to another member and the arthropods that can be present therein.

The apparatus and methods herein can be combined with other methods and apparatus directed to monitoring and/or controlling other insect pests, such as ants. Those skilled in the art will appreciate that numerous changes and modifications can be made to the preferred embodiments of the invention and that such changes and modifications can be made without departing from the spirit of the invention. It is therefore intended that the appended claims cover all such equivalent variations as fall within the true spirit and scope of the invention.

We claim:

1. An arthropod monitoring station comprising:
a housing having a first end, a second end, and a lateral wall extending between said first end and said second end, wherein;
said first end, second end, and lateral wall substantially define an interior portion of said housing; and
at least one of said first end, said second end, and said lateral wall includes at least one aperture suitable for ingress or egress by an arthropod with respect to said interior portion of said housing; and
at least two members disposed within said housing, wherein:
each of said members has a first end, a second end, and a lateral wall extending between said first end and said second end;
each of said members is disposed within said housing such that said lateral walls of said members are substantially parallel to each other and to said-lateral wall of said housing; and
at least one of said members comprises a material capable of being consumed by arthropods, a material capable of being penetrated by arthropods, a material capable of being transported by arthropods, or a material capable of killing arthropods.

2. The station of claim 1 wherein said ends are, independently, substantially in the form of a cone or a plate.

3. The station of claim 1 wherein said lateral wall of said housing includes at least one aperture suitable for ingress or egress by an arthropod.

4. The station of claim 1 wherein at least one of said housing and said members has a lateral cross-section substantially defining a closed surface shape.

5. The station of claim 4 wherein said housing and at least one of said members both have a lateral cross-section substantially defining a closed surface shape and said shapes are the same.

6. The station of claim 5 wherein said shape is selected from the group consisting of circles, triangles, tetrahedrons, pentagons, hexagons, heptagons, and octagons.

7. The station of claim 1 wherein at least one of said ends includes an element that is transparent.

8. The station of claim 1 wherein said material capable of being consumed by arthropods is wood or cardboard.

9. The station of claim 8 wherein said material is wood and said wood is present in an amount greater than about 30 grams.

10. The station of claim 1 wherein said material capable of being penetrated by arthropods is a polymeric foam.

11. The station of claim 1 wherein at least one of said members is a substantially monolithic mass of material.

12. The station of claim 11 wherein said mass is a substantially rectilinear block or a substantially cylindrical block.

13. The station of claim 12 wherein said block includes at least one groove on its surface.

14. The station of claim 11 wherein said member is a block of wood.

15. The station of claim 11 wherein each of said at least two members is a block of wood.

16. The station of claim 15 wherein said blocks have a cumulative weight that is greater than about 60 grams.

17. The station of claim 1 wherein said ends and said lateral wall of said housing are formed from a synthetic polymer.

18. The station of claim 1 wherein at least one of said ends and said lateral wall of said housing is formed from a synthetic polymer.

19. The station of claim 18 wherein lateral wall of said housing is formed from synthetic polymer and includes at least one integral protrusion that is within said housing and that substantially conforms to at least one of said members.

20. The station of claim 19 wherein said protrusion is substantially aligned with an aperture in said lateral wall of said housing suitable for ingress or egress by an arthropod.

21. The station of claim 1 wherein said housing comprises a member having a first end, a second end, and a lateral wall that substantially defines an interior portion of said member.

22. The station of claim 21 wherein said ends are, independently, substantially in the form of a cone or a plate.

23. The station of claim 21 wherein said interior portion of said member includes water, a material capable of being consumed by arthropods, a material capable of being penetrated by arthropods, a material capable of being transported by arthropods, or a material capable of killing arthropods.

24. The station of claim 21 wherein said interior portion of said member includes a device that emits a signal when an arthropod is present within said interior portion of said housing.

25. The station of claim 21 wherein said first end of said member, said second end of said member, or said lateral wall of said member includes at least one aperture suitable for ingress or egress by an arthropod with respect to said interior portion of said member.

26. The station of claim 21 wherein both of said ends of said member include elements that are permanently affixed to said lateral wall of said member.

27. The station of claim 26 wherein said member having permanently-affixed end elements includes a material capable of killing arthropods.

28. The station of claim 21 wherein at least one of said ends includes an element that is transparent.

29. The station of claim 1 wherein said members are positioned adjacent one another.

30. The station of claim 1 wherein said interior portion of said housing includes a material capable of being consumed by arthropods, a material capable of being penetrated by arthropods, a material capable of being transported by arthropods, or a material capable of killing arthropods.

31. The station of claim 30 wherein said material is disposed between said members.

32. The station of claim 30 wherein said material is disposed between said housing and at least one of said members.

33. The station of claim 30 wherein said material is disposed between said members and between said housing and at least one of said members.

34. The station of claim 33 wherein said material contacts said members and said housing.

35. The station of claim 30 wherein said material is in the form of a substantially monolithic mass.

36. The station of claim 35 wherein said mass is a substantially rectilinear block or a substantially cylindrical block.

37. The station of claim 35 wherein said mass substantially conforms to at least a portion of said lateral wall of said housing.

38. The station of claim 37 wherein said lateral wall of said housing has a length and said mass is in the form of a block having a length that is at least about 66% of said length of said lateral wall.

39. The station of claim 37 wherein said lateral wall of said housing has a length and said mass is in the form of at least one plate having a thickness that is less than about 1-2% of said length of said lateral wall.

40. The station of claim 39 wherein said plate comprises a plurality of grooves, said grooves defining at least one containment channel.

41. The station of claim 35 wherein said mass substantially conforms to at least a portion of said members.

42. The station of claim 35 wherein said mass substantially conforms to at least a portion of said members and to at least a portion of said lateral wall of said housing.

43. The station of claim 30 wherein said material is in the form of a sleeve.

44. The station of claim 43 wherein said sleeve substantially conforms to at least one of said members or said housing.

45. The station of claim 1 wherein said housing has a lateral cross-section having a diameter of about 0.5 inches to about 6 inches.

46. The station of claim 1 wherein said lateral wall of said housing has a length of about 4 inches to about 10 inches.

47. The station of claim 1 wherein at least one of said members has a lateral cross-section having a diameter of about 0.5 inches to about 3 inches.

48. The station of claim 1 wherein said lateral wall of at least one of said members has a length of about 4 inches to about 9 inches.

49. The station of claim 1 wherein:
said interior portion of said housing includes a substantially monolithic mass of a material that is capable of being consumed, penetrated, or transported by arthropods;
said material is disposed between said members and between said housing and at least one of said members so as to support said at least one of said members.

50. The station of claim 1 further comprising at least one additional member disposed within said housing.

51. The station of claim 50 comprising three of said members disposed within said housing.

52. The station of claim 1 further comprising a collar element surrounding said housing proximate at one of its ends, wherein said collar comprises:
a first face, a second face opposite said first face, and an outer edge between said first face and said second face; and
a containment ridge protruding from said first face along at least a portion of said outer edge, said containment ridge defining a containment region proximate said first face.

53. The station of claim 52 wherein said first end includes an element comprising a plurality of guide ridges that protrude from said first face and define at least one containment channel.

54. A method comprising implanting at least one station of claim 1 in soil.

55. The method of claim 54 wherein said station is implanted in soil within about 1-2 feet of a building.

56. The method of claim 55 further comprising identifying said building as one suspected to suffer from arthropod infestation before implanting said station.

57. The method of claim 55 in which at least two of said stations are implanted in soil within about 10 feet of each other.

58. The method of claim 54 wherein a portion of said lateral wall of said housing extends above said soil.

59. A method comprising inspecting the station of claim 1 for arthropod activity.

60. The method of claim 59 further comprising placing at least one additional member in said housing.

61. The method of claim 59 further comprising removing at least one of said members from said housing.

62. The method of claim 61 further comprising disposing at least one additional member in said housing in place of said removed member.

63. The method of claim 59 wherein at least one of said members is a block of wood, further comprising:
removing said block of wood from said housing; and
replacing said block of wood with a replacement member having a first end, a second end, and a lateral wall that substantially defines an interior portion of said member.

64. The method of claim 63 wherein said replacement member includes a material capable of killing arthropods.

65. The method of claim 63 wherein both of said ends of said replacement member include elements that are permanently affixed to said lateral wall of said replacement member.

66. The method of claim 59 wherein at least one of said members is a placeholder member, further comprising:
removing said placeholder member from said housing, wherein said member has a first end, a second end, and a lateral wall that substantially defines an interior portion of said member; and
replacing said placeholder member with a block of wood.

67. The method of claim 59 wherein at least one of said members is a placeholder member, further comprising:
removing said placeholder member from said housing, wherein said member has a first end, a second end, and a lateral wall that substantially defines an interior portion of said member; and
replacing said placeholder member with a replacement member having a first end, a second end, a lateral wall that substantially defines an interior portion of said member, and a material capable of killing arthropods in said interior portion of said replacement member.

68. The method of claim 67 wherein both of said ends of said replacement member include elements that are permanently affixed to said lateral wall of said replacement member.

70. An arthropod monitoring station comprising:
a housing having a first end, a second end, and a lateral wall extending between said first end and said second end, wherein;
said first end, second end, and lateral wall substantially define an interior portion of said housing; and
at least one of said first end, said second end, and said lateral wall includes at least one aperture suitable for ingress or egress by an arthropod with respect to said interior portion of said housing; and
a material disposed within said housing that is capable of being consumed by arthropods, wherein said material is present in an amount greater than about 30 grams.

71. An arthropod monitoring system comprising:
a housing having a first end element, a second end element, and a lateral wall extending between said first end element and said second end element, wherein;
said first end element, second end element, and lateral wall substantially define an interior portion of said housing; and
at least one of said first end element, said second end element, and said lateral wall includes at least one aperture suitable for ingress or egress by an arthropod with respect to said interior portion of said housing; and
at least two members disposed within said housing, wherein:
each of said members has a first end, a second end, and a lateral wall extending between said first end and said second end;
each of said members is disposed within said housing such that said lateral walls of said members are substantially parallel to each other and to said lateral wall of said housing;
at least one of said members comprises a material capable of being consumed by arthropods, a material capable of being penetrated by arthropods, a material capable of being transported by arthropods, or a material capable of killing arthropods; and
wherein at least a portion of said first end element of said housing is removably attached to said lateral wall of said housing.

72. The system of claim 71 wherein said first end element of said housing includes at least one protrusion that is external to said housing and has a lateral cross section.

73. The system of claim 72 wherein said protrusion has a lateral cross section corresponding to a closed surface shape.

74. The system of claim 72 wherein said protrusion has a lateral cross section corresponding to an open surface shape.

75. The system of claim 72 wherein said cross section is rectilinear.

76. The system of claim 72 wherein said protrusion comprises at least one recess.

77. The system of claim 72 further comprising a cooperative member that conforms to at least a portion of said protrusion to permit rotation of said first end element.

78. The system of claim 77 wherein said cooperative member is attached to a shaft and said shaft is attached to a handle.

79. A method comprising inspecting the system of claim 72 for arthropod activity.

80. A method comprising inspecting the system of claim 77 for arthropod activity comprising
contacting said cooperative member with said protrusion of said first end element;
rotating said first end element by turning said cooperative member; and
removing said first end element from said lateral wall.

81. The method of claim 80 wherein said first end element remains engaged to said cooperative element after removal of said first end element from said lateral wall.
